(19) United States
(12) Patent Application Publication
(10) Pub. No.: US 2024/0012963 A1
(43) Pub. Date: Jan. 11, 2024

(54) SYSTEMS AND METHODS FOR DETERMINING POTENTIAL TRAFFIC PATTERNS WITHIN AN INTERIOR PHYSICAL SPACE AND DETERMINING A FURNISHING LAYOUT FOR THE INTERIOR PHYSICAL SPACE BASED ON THE POTENTIAL TRAFFIC PATTERNS

(71) Applicant: Homster Inc., Walnut, CA (US)

(72) Inventors: Arda Kaya, Istanbul (TR); Mustafa Baris Bal, Seoul (KR)

(21) Appl. No.: 17/859,810

(22) Filed: Jul. 7, 2022

(51) Int. Cl. G06F 30/27; G06F 30/12; G06F 30/13; G06Q 30/06; G06T 19/00

(52) U.S. Cl. CPC G06F 30/27; G06F 30/12; G06F 30/13; G06Q 30/0643; G06T 19/003; G06F 2111/18

(57) ABSTRACT

System and method for determining potential traffic patterns within an interior physical space and determining a furnishing layout for the interior physical space based on the potential traffic patterns. Exemplary implementations may: obtain a model characterizing an interior physical space; obtain a number of occupants utilizing the interior physical space; analyze the obtained model to determine potential traffic patterns within the interior physical space; based on the analysis of the obtained model, generate an activity map that includes a two-dimensional model characterizing the interior physical space; based on the activity map and the obtained model, determine a furnishing layout for the interior physical space; output the furnishing layout, and/or other exemplary implementations.

### FIELD OF THE DISCLOSURE

The present disclosure relates to systems and methods for determining potential traffic patterns within an interior physical space and determining a furnishing layout for the interior physical space based on the potential traffic patterns.

### BACKGROUND

Methods for generating furnishing suggestions for interior spaces are known. Furnishing layouts may depict locations for items of furniture to be placed within the interior space. Methods for providing users with the furnishing layouts are known.

### SUMMARY

One or more aspects of the present disclosure include a system for determining potential traffic patterns within an interior physical space and determining a furnishing layout for the interior physical space based on the potential traffic patterns. The system may include electronic storage, one or more hardware processors configured by machine-readable instructions and/or other components. Executing the machine-readable instructions may cause the one or more hardware processors to facilitate determining potential traffic patterns within an interior physical space and/or determining a furnishing layout for the interior physical space based on the potential traffic patterns. The machine-readable instructions may include one or more computer program components. The one or more computer program components may include one or more of a model component, an activity component, a furnishing component, and/or other components.

The model component may be configured to obtain a model characterizing an interior physical space. The model may include characterizations of features included in the interior physical space and/or other information. The features may include rooms, hallways, doors, walls, floors, stairs, and/or other components of the interior physical space.

The model component may be configured to obtain a number of occupants utilizing the interior physical space, and/or other information.

The activity component may be configured to analyze the obtained model to determine potential traffic patterns within the interior physical space. Individual potential traffic patterns may characterize likely occupant locomotion within the interior physical space. Likely occupant locomotion may be defined by an area within the interior physical space where the locomotion occurs, a frequency at which the locomotion occurs, and/or other information. The determination of potential traffic patterns may be based in part on the model characterizing the interior physical space, the number of occupants utilizing the interior physical space, and/or other information.

The activity component may be configured to generate an activity map based on the analysis of the obtained model. The activity map may include a two-dimensional model characterizing the interior physical space. The two-dimensional model may include representations of the potential traffic patterns and/or other information.

The furnishing component may be configured to determine a furnishing layout for the interior physical space based on the activity map and/or the obtained model. The furnishing layout may include representations of items of furniture, positions within the interior physical space associated with the items of furniture, and/or other information.

The furnishing component may be configured to output the furnishing layout.

These and other features, and characteristics of the present technology, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system for determining potential traffic patterns within an interior physical space and determining a furnishing layout for the interior physical space based on the potential traffic patterns, in accordance with one or more implementations.

FIG. 2 illustrates a method for determining potential traffic patterns within an interior physical space and determining a furnishing layout for the interior physical space based on the potential traffic patterns, in accordance with one or more implementations.

FIGS. 3A-B illustrates an exemplary implementation of the system for determining potential traffic patterns within an interior physical space and determining a furnishing layout for the interior physical space based on the potential traffic patterns, in accordance with one or more implementations.

FIG. 4 illustrates an exemplary user interface, in accordance with one or more implementations.

### DETAILED DESCRIPTION

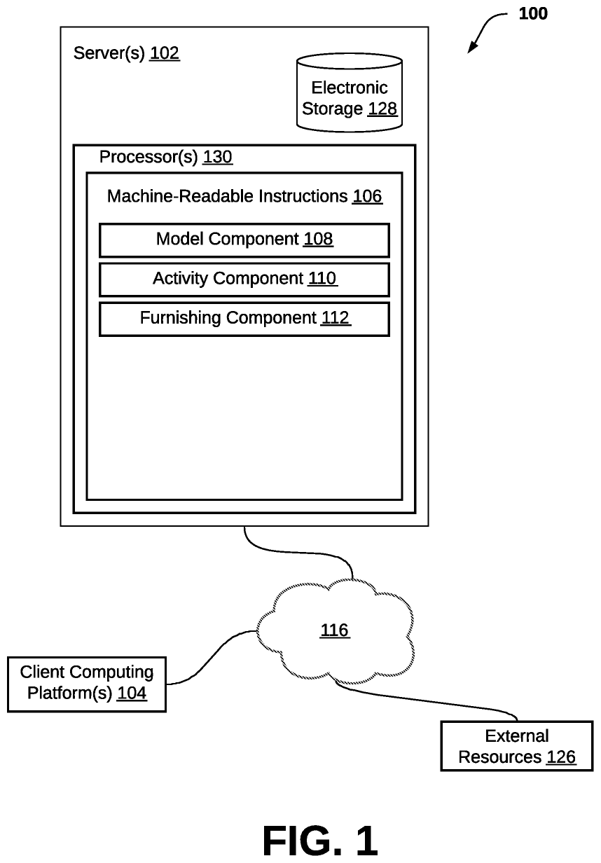

FIG. 1 illustrates a system 100 configured for determining potential traffic patterns within an interior physical space and/or determining a furnishing layout for the interior physical space based on the potential traffic patterns, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of model component 108, activity component 110, furnishing component 112, and/or other instruction components.

Model component 108 may be configured to obtain a model characterizing an interior physical space. Interior physical spaces may include houses, apartments, offices, churches, stores, restaurants, warehouses, and/or other types of interior spaces. Interior physical spaces may include one or more features. Features of interior physical spaces may include rooms, hallways, doors, walls, floors, stairs, and/or other aspects of the interior physical spaces. Features of an interior physical space may be built into (i.e., not readily removable) from the interior physical space. The model may include characterizations of features included in the interior physical space and/or other information. The characterizations of features may include figures, images, labels, and/or other methods of depicting the features within the model.

In some implementations, the model may be obtained from external resources 126 (i.e., via networks 116) and/or components of system 100. External resources 126 may include one or more databases configured to store models of interior physical spaces. The databases may be public or private (i.e., requiring permissions for access). In some implementations, the model may be obtained from a user via client computing platform(s) 104. Users may be capable of importing (i.e., uploading) one or more models via client computing platforms(s) 104. Client computing platforms 104 may include a capture device (i.e., camera) configured to scan the interior physical space. Scanning the interior physical space may include capturing a video of the interior physical space and/or capturing a picture of the interior physical space. In some implementations, model component 108 may be configured to generate a model characterizing the interior physical space based on the captured video and/or picture of the interior physical space. The captured video and/or picture of the interior space may include portions of the interior physical space or the whole of the interior physical space.

In some implementations, the obtained model may be a three-dimensional model, a two-dimensional model (i.e., floorplan, layout, blueprint, etc.), and/or other types of models. A three-dimensional model may be constructing (e.g., based on captured video of the interior physical space, scan of the interior physical space, etc.) using polygonal modeling, curve modeling, digital sculpting, and/or other methods of three-dimensional modeling. A two-dimensional model may characterize a top-down perspective, a one-point perspective, and/or other perspectives depicting the interior physical space and/or portions of the interior physical space. By way of non-limiting illustration, a top-down perspective of the interior physical space may characterize the arrangement of one or more rooms and/or other features included in the interior physical space. The top-down perspective may show an aerial view of the interior physical space.

Model component 108 may be configured to obtain a number of occupants utilizing the interior physical space and/or other information. The number of occupants may include a total number of occupants that are anticipated to utilize the interior physical space within a given duration of time. By way of non-limiting illustration, the number of occupants may represent the projected number of people to enter an interior physical space (e.g., a store, a restaurant, etc.) within a period of 10 minutes, 15 minutes, 30 minutes, and/or other durations of time. In some implementations, the number of occupants may represent the number of residents that reside in the interior physical space (e.g., a house, an apartment, etc.). By way of non-limiting illustration, the number of occupants may represent the number of household members for a given house. The number of occupants may include pets. In some implementations, model component 108 may be configured to obtain information pertaining to the occupants of the interior physical space. Information may include occupant age, gender, room assignment, role (e.g., customer, employee, household member, etc.), and/or other information. The number of occupants and/or information pertaining to the occupants may be obtained from one or more client computing platform(s) 104 associated with the user(s).

In some implementations, model component 108 may be configured to obtain a user's interior design style preference and/or other information. Interior design style preferences may include midcentury, minimal, rustic, industrial, and/or other design styles. The interior design style preferences may be used to determine items of furniture included in the furnishing layout. Model component 108 may be configured to obtain a household type. Household type may include single occupant, family (e.g., including children, parents, and/or other household members) occupant, and/or other household types. Model component 108 may be configured to obtain accessibility information associated with one or more occupants of the interior physical space. By way of non-limiting illustration, accessibility information may specify occupant disabilities requiring specific household features (e.g., wheelchair accessible showers, ramps, etc.). Model component 108 may be configured to obtain lifestyle information associated with the occupants. Lifestyle information may characterize work patterns (e.g., an occupant may work from home), exercise patterns (e.g., a number of times per week that an occupant exercises), and/or other types of patterns. In some implementations, lifestyle information may be obtained via external resources 126 and/or network(s) 116. By way of non-limiting illustration, data (i.e., associated with the occupant) may be obtained from one or more social media applications to determined lifestyle information.

Activity component 110 may be configured to analyze the obtained model to determine potential traffic patterns within the interior physical space. Individual potential traffic patterns may characterize likely occupant locomotion within the interior physical space. Likely occupant locomotion may be defined by the area within the interior physical space where the locomotion occurs, a frequency at which the locomotion occurs, and/or other information. Likely occupant locomotion may be further defined by one or more of a type of activity, a length of time in which the activity is performed, a number of occupants associated with the activity, and/or other features. For example, a first type of activity may be moving from a first room (e.g., a bedroom) to a second room (e.g., a bathroom). Another example of a second type of activity may be remaining in a third room (e.g., a kitchen). In some implementations, potential traffic patterns may identify areas within the interior physical space where high amounts of occupant traffic may occur. For example, an individual potential traffic pattern may identify a room, hallway, etc. where one or more paths corresponding to occupant locomotion may intersect.

In some implementations, the potential traffic patterns may be determined by replicating (i.e., modeling) occupant locomotion within the interior physical space for a given period of time. By way of non-limiting illustration, activity component 110 may be configured to model some or all instances of occupant locomotion within the interior physical space within the duration of 24 hours and/or other durations of time. Individual instances of occupant locomotion may represent an individual occupant performing an individual type of activity. By way of non-limiting illustration, modeling occupant locomotion for an interior physical space may yield 50 instances, 100 instances, 1000 instances, and/or other numbers of instances of occupant locomotion. For example, it may be determined that there are 50 instances of a first type of activity, 10 instances of the second type of activity, and/or other instances of other occupant locomotion. The determined potential traffic patterns may characterize occupant locomotion (or types of activity) that meet or exceed a frequency threshold and/or other metrics. In some implementations, the frequency threshold may be associated with the number of instances of the occupant locomotion. By way of non-limiting illustration, occupant locomotion associated with a number of instances meeting or exceeding 50 instances (i.e., the frequency threshold) may be determined to be a potential traffic pattern.

In some implementations, the potential traffic patterns may be determined based on scores that correspond to types of activity defined by occupant locomotion. Individual scores may be generated (e.g., by model component 108) for individual types of activity defined by occupant locomotion. The scores may represent the frequency and/or likelihood of the type of activity occurring within the interior physical space. For example, a third type of activity (e.g., moving from a kitchen to a living room) may correspond to a first score and a fourth type of activity (e.g., moving from an entryway to a bathroom) may correspond to a second score. The first score may be higher relative to the second score, thus indicating a higher relative likelihood of the third type of activity occurring compared to the fourth type of activity. Occupant locomotion defined by types of activity corresponding to scores that meet or exceed a threshold may be identified. The determination of potential traffic patterns may be based on one or more of the identified occupant locomotion, the scores corresponding to the types of activity, and/or other information.

In some implementations, the potential traffic patterns may be determined based on predetermined sets of human-environment interactions that are stored in electronic storage 128, obtained from external resources 126, and/or otherwise provided to system 100. Human-environment interactions may specify types of activity and/or occupant behavior that have the potential to occur in interior physical spaces. Electronic storage 128 may store information specifying one or more sets of human-environment interactions. Different sets of human-environment interactions may correspond to different types of interior physical spaces. For example, human-environment interactions within residential spaces may be different from human-environment interactions within commercial spaces. Human-environment interactions may specify human fulfillment of biological needs (e.g., sleeping, eating, etc.) and/or other types of human behavior. In some implementations, the potential traffic patterns may be determined based on the fulfillment of the biological needs of the occupants.

In some implementations the determination of potential traffic patterns may be based on the number of occupants within the interior physical space. For example, a first interior physical space having a first number of occupants may be determined to have potential traffic patterns that are different from the first interior physical space having a second number of occupants. The first number of occupants may be different from the second number of occupants.

Activity component 110 may be configured to generate an activity map for the interior physical space based on the analysis of the obtained model and/or the determined potential traffic patterns. The activity map may be a two-dimensional model, a three-dimensional model, and/or other type of model characterizing the interior physical space. An activity map including a two-dimensional model may include representations of some or all of the potential traffic patterns and/or other information. By way of non-limiting illustration, representations of the potential traffic patterns may be superimposed over the two-dimensional model. Individual representations of the potential traffic patterns may include (i.e., show, depict) representations of the frequencies at which the locomotion occurs and/or other features defining the potential traffic patterns. For example, representations of the potential traffic patterns may include numerical representations of the frequencies (e.g., a number between 1 and 10). Representations of the potential traffic patterns may include distinguishing colors, shapes, and/or other elements for representing the frequencies. By way of non-limiting illustration, potential traffic patterns defined by a low frequency of occurring may be represented by red lines, dots, and/or other elements. Potential traffic patterns defined by a high frequency of occurring may be represented by green lines, dots, and/or other elements.

Furnishing component 112 may be configured to determine a furnishing layout for the interior physical space based on one or more of the activity map, the obtained model, and/or other information. The items of furniture may be defined by a type of furniture, a size of furniture, a style of furniture, and/or other aspects. The furnishing layout may include representations of items of furniture, positions within the interior physical space associated with the items of furniture, and/or other information. The positions within the interior physical space associated with the items of furniture specify the recommended locations for the items of furniture to be placed based on the potential traffic patterns. In some implementations, the furnishing layout may be a two-dimensional model (e.g., depicting a top-down perspective), a three-dimensional model, and/or other types of models characterizing the interior physical space.

In some implementations, the furnishing layout for the interior physical space may be determined to reduce the number of collisions of occupants during locomotion defined by the potential traffic patterns. The furnishing layout may be determined to increase the flow of locomotion defined by the potential traffic patterns. By way of non-limiting illustration, the furnishing layout may be determined to facilitate locomotion (defined by the potential traffic patterns) corresponding to relatively higher frequencies of occurring. For further illustration, the furnishing layout may specify items of furniture and/or the absence of items of furniture within areas of the interior physical space that experience relatively high occupant traffic based on the potential traffic patterns.

Furnishing component 112 may be configured to output the furnishing layout. In some implementations, outputting the furnishing layout may include presenting the furnishing layout to a user via a user interface of client computing platform(s) 104. The user interface may include one or more user interface elements corresponding to individual items of furniture included in the furnishing layout. The user interface elements may be selectable by the user. Selection of the user interface elements may facilitate the user purchasing the items of furniture corresponding to the selected user interface elements. By way of non-limiting illustration, the user interface elements may include hyperlinks to third-party applications (e.g., furniture vendors).

In some implementations, presenting the furnishing layout to a user may include presenting a first-person perspective of the interior physical space depicting the representations of the items of furniture. The presentation may be navigable by the user and/or controlled by user input, such that the user appears to navigate through the interior physical space (e.g., virtual reality presentation). The presentation may allow the user to observe the appearance of the items of furniture placed within the interior physical space.

In some implementations, the obtained model characterizing the interior physical space, the activity map, the number of occupants, the furnishing layout and/or other information may be provided as a training input/output pair and/or other input/output pairs to train a machine learning model. The machine learning model may be trained to determine potential traffic patterns, determine an activity map for an interior physical space, and/or determine an furnishing layout for the interior physical space. In some implementations, the machine learning model may utilize one or more of an artificial neural network, naïve bayes classifier algorithm, k means clustering algorithm, support vector machine algorithm, linear regression, logistic regression, decision trees, random forest, nearest neighbors, and/or other approaches. The machine learning model may utilize training techniques such as supervised learning, semi-supervised learning, unsupervised learning, reinforcement learning, and/or other techniques.

Electronic storage 128 may store the trained machine learning model. In some implementations, activity component 110 may be configured to obtain and utilize the trained machine learning model from electronic storage 128 to determine potential traffic patterns and/or an activity map for an interior physical space. In some implementations, furnishing component 110 may be configured to obtain and utilize the trained machine learning model from electronic storage 128 to determine furnishing layout for the interior physical space.

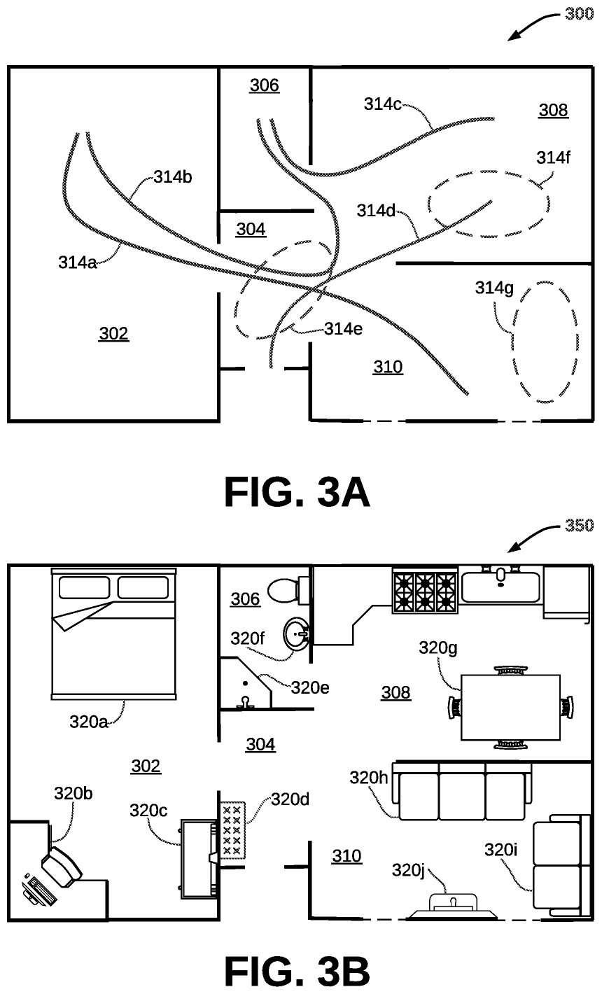

FIGS. 3A-B illustrate an exemplary implementation of the system for determining potential traffic patterns within an interior physical space and determining a furnishing layout for the interior physical space based on the potential traffic patterns, in accordance with one or more implementations. FIG. 3A shows an activity map 300 for an interior physical space having one or more features. The features may be characterized by activity map 300. The characterized features may include one or more rooms such as a bedroom 302, an entryway 304, a bathroom 306, a kitchen 308, a living room 310, and/or other features of the interior physical space. Activity map 300 may include one or more representations of potential traffic patterns 314a-g and/or other elements. In some implementations, potential traffic patterns 314a-d may characterize occupant locomotion defined by movement (represented by lines) throughout the interior physical space. By way of non-limiting illustration, potential traffic pattern 314a may characterize occupant locomotion defined by movement from bedroom 302 to living room 310, or vice versa. In some implementations, potential traffic patterns 314e-g may characterize areas within the interior physical space that experience a high volume of occupant traffic or areas where occupants may remain for an extended period of time (represented by dashed ovals). By way of non-limiting illustration, potential traffic pattern 314e may specify an area of the interior physical space experiencing a high volume of occupant traffic and/or may require fewer items of furniture. Potential traffic pattern 314f may specify an area of the interior physical space where occupants may remain for an extended period of time (e.g., for eating, resting, socializing and/or other purposes) and/or require more items of furniture. FIG. 3B shows a furnishing layout 350 for the interior physical space. Furnishing layout 350 may be determined based on activity map 300. In some implementations, furnishing layout may characterize features of the interior physical space that are the same as or similar to the characterization of features included in activity map 300. Furnishing layout 350 may include one or more representations of items of furniture 320a-j and/or other elements. The representations of items of furniture 320a-j may be positioned within furnishing layout 350 to reflect recommended positions within the interior physical space for the items of furniture.

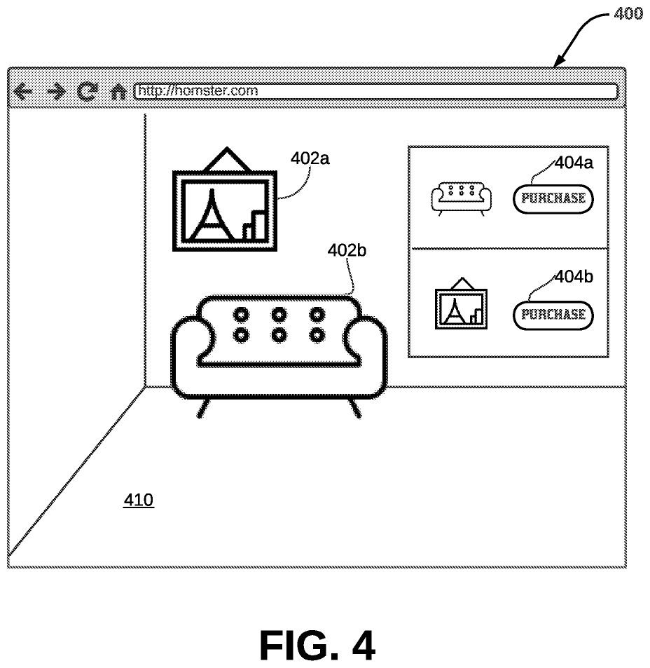

FIG. 4 illustrates a user interface 400 that may be utilized by a system to determine potential traffic patterns within an interior physical space and determine a furnishing layout for the interior physical space based on the potential traffic patterns, in accordance with one or more implementations. User interface 400 may be configured to present a furnishing layout 410 to a user via a client computing platform (the same as or similar to client computing platform(s) 104, as shown in FIG. 1). The presentation of furnishing layout 410 may depict a first-person perspective of the interior physical space, as shown. Furnishing layout 410 may include representations of items of furniture 402a-b positioned within a characterization (e.g., model) of an interior physical space. User interface 400 may include one or more user interface elements 404a-b corresponding to representations of items of furniture 402a-b, accordingly. User interface elements 404a-b may be selectable by the user and/or facilitate purchase of the items of furniture associated with representations 402a-b.

Referring to FIG. 1, server(s) 102, client computing platform(s) 104, and/or external resources 126 may be operatively linked via one or more electronic communication links. By way of non-limiting illustration, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. By way of non-limiting illustration, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, by way of non-limiting illustration, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, and/or 112, and/or other components. Processor(s) 130 may be configured to execute components 108, 110, and/or 112, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. By way of non-limiting illustration, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed below to one of components 108, 110, and/or 112.

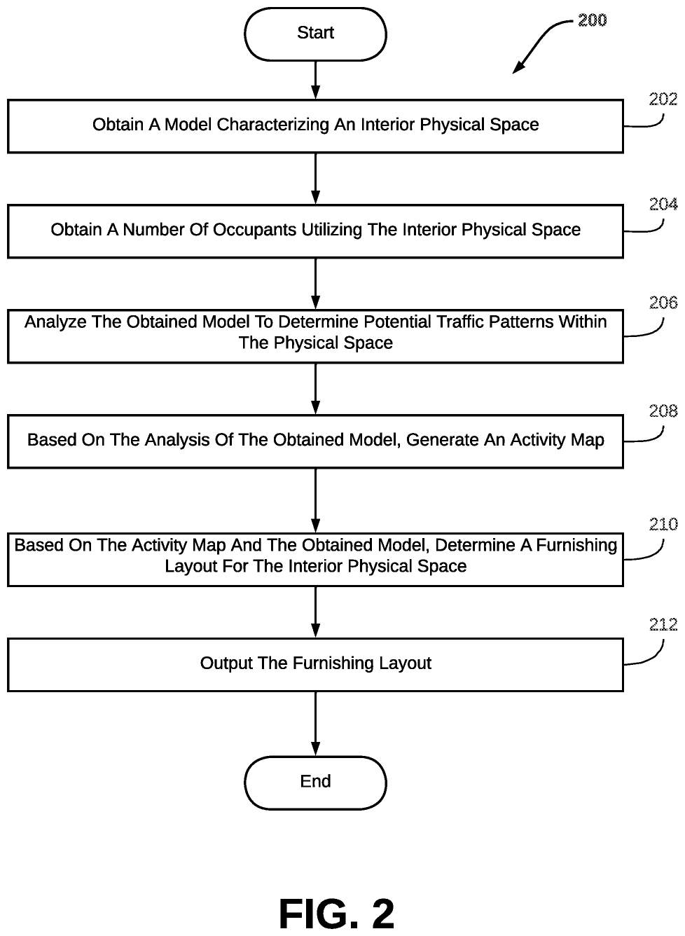

FIG. 2 illustrates a method 200 for determining potential traffic patterns within an interior physical space and/or determining a furnishing layout for the interior physical space based on the potential traffic patterns, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining a model characterizing an interior physical space. The model may include characterizations of features included in the interior physical space and/or other information. The features may include rooms, hallways, doors, walls, floors, stairs, and/or other components of the interior physical space. Operation 202 may be performed by a component that is the same as or similar to model component 108, in accordance with one or more implementations.

An operation 204 may include obtaining a number of occupants utilizing the interior physical space and/or other information. Operation 204 may be performed by one or more hardware processors configured by machine-readable instructions including a component that is the same as or similar to model component 108, in accordance with one or more implementations.

An operation 206 may include analyzing the obtained model to determine potential traffic patterns within the interior physical space. Individual potential traffic patterns may characterize likely occupant locomotion within the interior physical space. Likely occupant locomotion may be defined by an area within the interior physical space where the locomotion occurs, a frequency at which the locomotion occurs, and/or other information. The determination of potential traffic patterns may be based in part on the model characterizing the interior physical space, the number of occupants utilizing the interior physical space, and/or other information. Operation 206 may be performed by one or more hardware processors configured by machine-readable instructions including a component that is the same as or similar to activity component 110, in accordance with one or more implementations.

An operation 208 may include generating an activity map based on the analysis of the obtained model. The activity map may include a two-dimensional model characterizing the interior physical space. The two-dimensional model may include representations of the potential traffic patterns and/or other information. Operation 208 may be performed by one or more hardware processors configured by machine-readable instructions including a component that is the same as or similar to activity component 110, in accordance with one or more implementations.

An operation 210 may include determining a furnishing layout for the interior physical space based on the activity map and/or the obtained model. The furnishing layout may include representations of items of furniture, positions within the interior physical space associated with the items of furniture, and/or other information. Operation 210 may be performed by one or more hardware processors configured by machine-readable instructions including a component that is the same as or similar to furnishing component 112, in accordance with one or more implementations.

An operation 212 may include outputting the furnishing layout. Operation 212 may be performed by one or more hardware processors configured by machine-readable instructions including a component that is the same as or similar to furnishing component 112, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. By way of non-limiting illustration, it is to be understood that the present technology contemplates that, to the extent possible, one or more features of any implementation can be combined with one or more features of any other implementation.

What is claimed:

1. A system configured to determine potential traffic patterns within an interior physical space and determine a furnishing layout for the interior physical space based on the potential traffic patterns, the system comprising:
one or more physical processor configured by machine-readable instructions to:
obtain a model characterizing an interior physical space, wherein the model includes characterizations of features included in the interior physical space;
obtain a number of occupants utilizing the interior physical space;
analyze the obtained model to determine potential traffic patterns within the interior physical space, wherein individual potential traffic patterns characterize likely occupant locomotion within the interior physical space, wherein likely occupant locomotion is defined by an area within the interior physical space where the locomotion occurs and a frequency at which the locomotion occurs, and wherein the determination of potential traffic patterns are based in part on at least the model characterizing the interior physical space and the number of occupants utilizing the interior physical space;
based on the analysis of the obtained model, generate an activity map that includes a model characterizing the interior physical space, wherein the activity map includes representations of the potential traffic patterns;
based on the activity map and the obtained model, determine a furnishing layout for the interior physical space, wherein the furnishing layout includes representations of items of furniture and positions within the interior physical space associated with the items of furniture; and
output the furnishing layout.

2. The system of claim 1, wherein likely occupant locomotion is further defined by at least one of a type of activity, a length of time in which the activity is performed, and/or a number of occupants associated with the activity.

3. The system of claim 1, wherein the potential traffic patterns are determined based on predetermined sets of human-environment interactions, wherein human-environment interactions specify types of occupant behaviors that have the potential to occur in interior physical spaces.

4. The system of claim 1, wherein the furnishing layout is a two-dimensional model characterizing a top-down view of the interior physical space or a three-dimensional model.

5. The system of claim 1, wherein features of the interior physical space include rooms, hallways, doors, windows, walls, floors, and/or stairs.

6. The system of claim 1, wherein outputting the furnishing layout includes presenting the furnishing layout to a user via a user interface, wherein the user interface includes one or more user interface elements corresponding to individual items of furniture included in the furnishing layout.

7. The system of claim 6, wherein the user interface elements are selectable by the user, and wherein selection of the user interface elements facilitates the user purchasing the items of furniture corresponding to the selected user interface elements.

8. The system of claim 6, wherein presenting the furnishing layout to a user includes presenting a first-person perspective of the interior physical space including the representations of the items of furniture, wherein the presentation allows the user to navigate through the interior physical space in the first-person perspective.

9. The system of claim 1, wherein the determination of potential traffic patterns is based on the number of occupants within the interior physical space, such that a first interior physical space having a first number of occupants is determined to have potential traffic patterns that are different from the first interior physical space having a second number of occupants, wherein the first number of occupants is different from the second number of occupants.

10. The system of claim 1, wherein the activity map is a two-dimensional top-down view characterizing the interior physical space and the determined potential traffic patterns.

11. A method for determining potential traffic patterns within an interior physical space and determining a furnishing layout for the interior physical space based on the potential traffic patterns, the method comprising:
obtaining a model characterizing an interior physical space, wherein the model includes characterizations of features included in the interior physical space;
obtaining a number of occupants utilizing the interior physical space;
analyzing the obtained model to determine potential traffic patterns within the interior physical space, wherein individual potential traffic patterns characterize likely occupant locomotion within the interior physical space, wherein likely occupant locomotion is defined by an area within the interior physical space where the locomotion occurs and a frequency at which the locomotion occurs, and wherein the determination of potential traffic patterns are based in part on at least the model characterizing the interior physical space and the number of occupants utilizing the interior physical space;
based on the analysis of the obtained model, generating an activity map that includes a model characterizing the interior physical space, wherein the activity map includes representations of the potential traffic patterns;
based on the activity map and the obtained model, determining a furnishing layout for the interior physical space, wherein the furnishing layout includes representations of items of furniture and positions within the interior physical space associated with the items of furniture; and
outputting the furnishing layout.

12. The method of claim 11, wherein likely occupant locomotion is further defined by at least one of a type of activity, a length of time in which the activity is performed, and/or a number of occupants associated with the activity.

13. The method of claim 11, wherein the potential traffic patterns are determined based on predetermined sets of human-environment interactions, wherein human-environment interactions specify types of occupant behaviors that have the potential to occur in interior physical spaces.

14. The method of claim 1, wherein the furnishing layout is a two-dimensional model characterizing a top-down view of the interior physical space or a three-dimensional model.

15. The method of claim 1, wherein features of the interior physical space include rooms, hallways, doors, windows, walls, floors, and/or stairs.

16. The method of claim 1, wherein outputting the furnishing layout includes presenting the furnishing layout to a user via a user interface, wherein the user interface includes one or more user interface elements corresponding to individual items of furniture included in the furnishing layout.

17. The method of claim 16, wherein the user interface elements are selectable by the user, and wherein selection of the user interface elements facilitates the user purchasing the items of furniture corresponding to the selected user interface elements.

18. The method of claim 6, wherein presenting the furnishing layout to a user includes presenting a first-person perspective of the interior physical space including the representations of the items of furniture, wherein the presentation allows the user to navigate through the interior physical space in the first-person perspective.

19. The method of claim 11, wherein the determination of potential traffic patterns is based on the number of occupants within the interior physical space, such that a first interior physical space having a first number of occupants is determined to have potential traffic patterns that are different from the first interior physical space having a second number of occupants, wherein the first number of occupants is different from the second number of occupants.

20. The method of claim 11, wherein the activity map is a two-dimensional top-down view characterizing the interior physical space and the determined potential traffic patterns.
